(19) United States
(12) Patent Application Publication
(10) Pub. No.: US 2006/0164727 A1
(43) Pub. Date: Jul. 27, 2006

(54) Wheel and Tire Visual Safety Spots

(76) Inventor: John Ronald Feemster, Saratoga, CA (US)

Correspondence Address: John R. Feemster, 18800 Ten Acres Road, Saratoga, CA, 95070, US

(21) Appl. No.: 10/905,921

(22) Filed: Jan. 26, 2005

(51) Int. Cl. G02B 5/12

(52) U.S. Cl. 359/524

(57) ABSTRACT

A movement-indicating vehicle tire includes a tire body of some color, having a tread and a pair of opposed sidewalls, and a contrasting colored safety spot located on the tire body. In a specific embodiment the safety spot is located on the tire tread. In another specific embodiment, the safety spot is located on a tire sidewall. In another embodiment a vehicle wheel has a rim, an outwardly facing surface of some color, and a contrasting colored safety spot located on the outwardly facing surface. Rotation of the tire and wheel causes the safety spot to provide visual indication of vehicle movement.

### FIELD OF THE INVENTION

The invention relates generally to vehicle motion and direction signals and indicators, and more particularly to a highly visible reflective or contrasting color visual safety spot, to be located on the tires or wheels of a vehicle, whereby movement of the vehicle is made apparent to motorists, pedestrians, or other observers by showing them a dynamic flashing, pulsating, or moving display, regardless of whether the vehicle has any electric lights on.

### BACKGROUND OF THE INVENTION

It is often difficult, especially at or after dusk, to determine visually whether a vehicle is moving. This is especially true where the subject vehicle does not have its lights illuminated. For example, when two vehicles are approaching an intersection, either driver may have difficulty determining whether the two vehicles are on a collision course. Similarly, when a following driver approaches a leading vehicle from behind, the approaching driver may have difficulty determining whether the vehicle ahead is moving, especially if the leading vehicle is moving slowly and does not have its lights turned on.

One rudimentary solution to this problem, limited in its application to increasing sideward visibility of a bicycle equipped with wire-spoke wheels, has been to clip small reflectors in the spokes of the bicycle wheels, so that a motorist approaching an intersection at approximately a right angle to the bicycle's direction of travel, if the driver has his headlights illuminated, sees the reflector trace a cycloidal path through the surrounding darkness, alerting him to the bicyclist's presence.

Various schemes of marker lights have been used since there have been motorcars, but they are dependent on the subject vehicle having its lights illuminated. Taillights may alert a following driver to the presence of a leading vehicle, but only if they are turned on, and even then they provide no indication whether the leading vehicle is moving. Taillight assemblies incorporating a reflector section may similarly indicate the presence of a leading vehicle, but provide no information as to whether that vehicle is moving. Brake lights may alert a following driver to the presence of the leading vehicle, and the fact that its brakes are being applied, but they do not light, and thus provide no information, where the lead vehicle is traveling at a steady speed, or is decelerating without braking.

What is needed is a means of visually alerting surrounding persons of the movement and approximate speed of a vehicle, from various viewing angles, including directly behind the vehicle, and doing so independently of whether the subject vehicle has its lights illuminated

### SUMMARY OF THE INVENTION

This need, and others that will become apparent, are met by adding a visually arresting safety spot to the wheels or tires of a vehicle, so that, upon rotation of the vehicle's tires, the safety spot produces a dynamic flashing, moving, or pulsating display, calling the attention of an observer to the presence and movement of the vehicle, and providing some indication of the vehicle's approximate speed.

This highly visible safety spot can be placed in various locations on the tire or wheel. The term “safety spot” includes both single and multiple spots. In one embodiment, the safety spot is located on the vehicle's tires, on the tread. In another embodiment, the safety spot is located on the tire sidewalls. In an advantageous embodiment, the safety spot is located on both tread and sidewalls. In yet another embodiment, the safety spot is located on the vehicle's wheels. In another embodiment, the safety spot is located upon detachable covers fitted to the vehicle's wheels. In another embodiment, the safety spot is located on both tires and wheels.

The safety spot is of various highly visible materials. In one embodiment, the safety spot is of a color that contrasts strongly with that of the wheel or tire upon which it is located. In another embodiment, the safety spot is of a highly reflective material.

The safety spot can be of any desired shape, including dots, stripes, and bands of this highly visible material.

The safety spot is incorporated on the tire body in various ways. In one set of embodiments, the safety spot is applied to an outer surface of the tire, by means including painting, spraying, and gluing. In another embodiment, the safety spot is similarly applied to an external surface of the vehicle wheel. In one advantageous embodiment, the safety spot is made a part of the tire structure by molding it directly into the body of the tire.

### BRIEF DESCRIPTION OF THE DRAWINGS

FIG. 1 shows a front view of a vehicle tire, with a safety spot traversing its tread section straight across, from one sidewall of the tire to the other sidewall.

FIG. 1 shows a front view of a vehicle tire, with a safety spot traversing its tread section straight across, from one sidewall of the tire to the other sidewall.

FIG. 3 shows a side view of a vehicle tire, illustrating some alternative configurations of safety spots located on a sidewall of the tire.

FIG. 4 shows a three-quarter view of a tire, including tread and one sidewall, with a safety spot on a sidewall, and a second safety spot on the tread.

FIG. 5 shows a three-quarter view of a tire, with a safety spot traversing both the tread and one sidewall.

FIG. 6 shows a cross-sectional view of a tire body, with safety spots extending across a tread section and a sidewall section.

FIG. 7 shows a side view of a vehicle wheel, with a safety spot located on a side of the wheel.

FIG. 8 shows a three-quarter view of a vehicle wheel, with a safety spot located on a protruding center section of the wheel.

### DETAILED DESCRIPTION OF THE INVENTION

The movement of a vehicle is rendered more apparent, especially at or after dusk, by displaying, on a tire or a wheel or both, of the vehicle a highly visible safety spot, which creates a flashing, moving, or pulsating display as viewed by an external observer. This safety spot is visible irrespective of whether the vehicle equipped with it has its electric lights illuminated, and irrespective of whether the vehicle is stationary, is moving at a steady speed, or is decelerating, with or without its brakes being applied or brake lights showing.

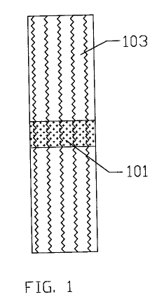

In one embodiment of the invention, a safety spot is located upon the tread section of the vehicle tire (This is a “tread safety spot.”). In one advantageous embodiment, illustrated in FIG. 1, a tread safety spot (101) extends straight across the tread section (103) of the vehicle tire, from sidewall to sidewall. As a vehicle equipped with such tires moves, the rotation of its wheel and tire cause the tread safety spot to be periodically exposed to view, so as to be perceived as flashing when viewed from behind the vehicle, for example from another vehicle approaching the equipped vehicle. The flashing effect is especially pronounced when the approaching vehicle's headlights shine on the equipped vehicle's tread safety spots.

When tires incorporating this embodiment of the invention are also mounted on the front end of the vehicle, a driver of an oncoming vehicle will see the same flashing effect when approaching the equipped vehicle from the front, again more pronounced if the driver's headlights illuminate the equipped vehicle's tread safety spots

The frequency of the perceived flashing effect gives an indication of the motion of the equipped vehicle, at least at slow speeds. A variation in the frequency of flashing over time gives an indication of whether the equipped vehicle is accelerating or decelerating.

In another embodiment, illustrated in FIG. 2, the safety spots (201) cross the tread section (203) of the tire from one sidewall to the other, not straight across the tread as in FIG. 1, but instead at an oblique angle. As a vehicle equipped with tires incorporating this embodiment moves, the rotation of its wheel and tire cause the tread safety spot to be periodically and progressively exposed to view, from one side of the tread to the other. This exposure of the tread safety spot is visually perceived not as a simple on-and-off flashing of the reflected light, but rather as an apparent side-to-side pulsating movement.

In each embodiment having safety spots located on the tire's tread section, the frequency of the flashing or pulsating effect is directly proportional to the speed of rotation of the tire, and therefore to the speed of the equipped vehicle. This frequency is also proportional to the number of tread safety spots placed on the tire—the greater the number, the more pronounced the flashing or pulsating effect will be at low vehicle speed, but the sooner the flashing will visually degrade into a constant wash of the brighter material as the speed of the equipped vehicle increases. For example, on a tire with an outside diameter of 2 feet, a single safety spot running straight across its tread section would yield a flashing rate of approximately 2⅓ flashes per second per 10 miles per hour of vehicle speed. At an assumed average flicker fusion rate (the rate of a flickering or flashing light at which a person ceases to perceive the flickering and instead sees the light as a constant source), of 16 times per second, the rotating tread safety spot would cease to be perceived by a following driver as flashing or pulsating at speeds in excess of around 65 miles per hour. Since the human eye is more capable of perceiving the flickering of a bright light source than of a dimmer one, and more capable of perceiving flickering in its peripheral vision than when looking straight at the source, the exposures of the safety spot will actually cease to be perceived as distinct flashes at a somewhat lower speed.

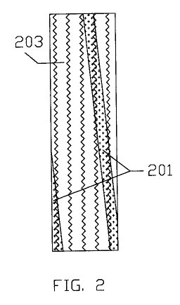

In another embodiment of the invention, illustrated by FIG. 3, one or more safety spots are located on a sidewall (301) of a vehicle tire. (This is a “sidewall safety spot.”) In one embodiment, each sidewall safety spot (303) takes the form of a single shape. In another embodiment, each sidewall safety spot (305) takes the form of a row of segments in the form of narrow stripes, each stripe extending circumferentially some fraction of the way around the sidewall. In an advantageous embodiment, each sidewall safety spot (307) takes the form of an area extending radially across the sidewall from a bead of the tire to the tread section of the tire. As a vehicle equipped with tires incorporating one of these embodiments moves, the rotation of its wheel and tire cause the sidewall safety spot to rotate. Other embodiments incorporate combinations of any two or all three of the safety spots (303, 305, and 307). The visual effect of the rotation of the sidewall safety spots, when seen from the side of the equipped vehicle, is of a cycloidal path traced through the darkness by each safety spot or, in the case of a segmented safety spot (like 305), by each segment of the safety spot. Like the flashing of the tread safety spots, these displays of motion created by the sidewall safety spots effectively signal the movement, and any increase or decrease in speed, of the equipped vehicle, again most effectively if the safety spots reflect the headlights of another vehicle. A particular embodiment, advantageous for use on two- or three-wheeled vehicles, where at least some of the tires have both sidewalls facing outward from the vehicle, incorporates safety spots on both sidewalls of the tire.

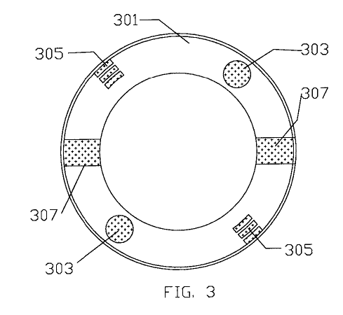

In another embodiment of the invention, illustrated by FIG. 4, the tire has both tread safety spots (401) on the tread (405), and sidewall safety spots (403) on at least one sidewall (407). In this embodiment, the safety spots are visible both from the side of the equipped vehicle and from in front of or behind the equipped vehicle. A viewer from any angle will perceive either the rotary motion of the sidewall safety spot, or the flashing or pulsating signal of the tread safety spot, or both. Another advantageous embodiment, for two- or three-wheeled vehicles, as discussed in the previous paragraph, has safety spots on the tread section and on both sidewalls.

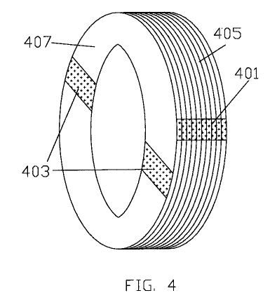

An advantageous embodiment, illustrated by FIG. 5, has each safety spot (501) wrap around the tire, crossing both the tread section (505) of the tire and at least one sidewall section (507) of the tire. A particularly advantageous embodiment has each safety spot wrap around the tire on both sides, crossing the tread section and both sidewall sections. A particular embodiment, also illustrated in FIG. 5, has each safety spot (501) wrapping around the tire, traversing each sidewall (507), and crossing straight across the tread section (505), like the tread safety spot (101) in FIG. 1, so as to be perceived from a direction radial to the tire as flashing. A second such embodiment has each safety spot wrapping around the tire, traversing each sidewall, and crossing the tread section at an oblique angle, like the tread safety spot (201) in FIG. 2, so as to be perceived from a direction radial to the tire as pulsating from side to side.

The safety spots can be painted, glued, sprayed, or otherwise applied to the external surfaces of the vehicle tires. Such external application of the safety spots results in some loss of effectiveness as the tires wear, particularly for any safety spots crossing the tread section where it makes contact with the pavement. However, where the tread safety spots are painted or sprayed on and cover the non-pavement-contacting bottoms of any tread grooves, those portions of the tread safety spots remaining on the bottoms of those grooves continue to perform their visual function even after the portions of the tread safety spots on the raised portions of the tread have worn off the tire. Also, where the tire incorporates safety spots on both the tread section and a sidewall section, the safety spots on the sidewall section are much less subject to such abrasive wear, and continue to perform their visual function even if the tread safety spots are entirely worn off the tire.

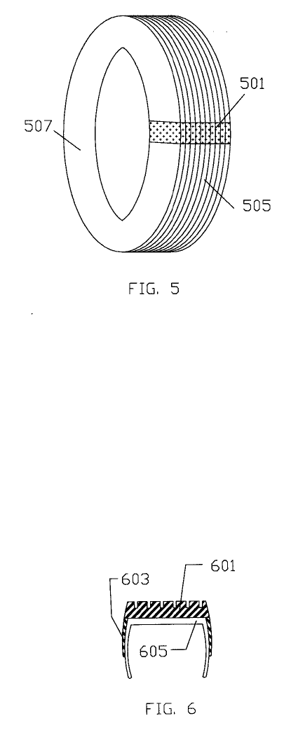

A more effective embodiment, which is illustrated in FIG. 6, incorporates the tread safety spot (601) into the tire by molding the safety spot into the body (605) of the tire at time of its manufacture. A particularly effective embodiment, also illustrated in FIG. 6, incorporates both the tread safety spot (601) and the sidewall safety spot (603) into the body of the tire by molding them into the tire body at time of manufacture. This has the advantage that the safety spots are then an integral part of the tire, less subject to abrasion and wearing or falling off than marks painted, glued, sprayed, or otherwise applied to the exterior surface of the tire. The tread safety spot, in particular, can be virtually the full thickness of the tire's tread section. This permits the tread safety spot to continue its visual signaling function, even on those areas where the tread is worn down by contact with the pavement, for essentially as long as there is any tread remaining on the tire. Given the less severe wear imposed on the sidewall section relative to the tread section, another embodiment has the tread safety spots molded integrally into the tread section of the tires, as discussed above, but the sidewall safety spots affixed to the tire's sidewall section using a surface application method such as gluing, painting, or spraying.

In a particularly advantageous embodiment, the safety spots are of a highly reflective material, for example (but not by way of limitation) Scotchlite® reflective medium. (Scotchlite is a registered trademark of the 3M Company.) In another very advantageous embodiment, the safety spots are both of a contrasting color to that of the tire body, and also of a highly reflective material.

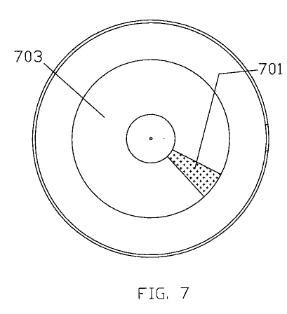

An alternative embodiment of the invention locates the safety spots on the wheels, including on wheelcovers and hubcaps, of the equipped vehicle, as illustrated in FIG. 7. (This is a wheel safety spot.) Safety spots (701) located on approximately flat wheels (703) produce a similar visual effect, when the vehicle moves and the wheels rotate, to that of the sidewall safety spots on the tires, as discussed above.

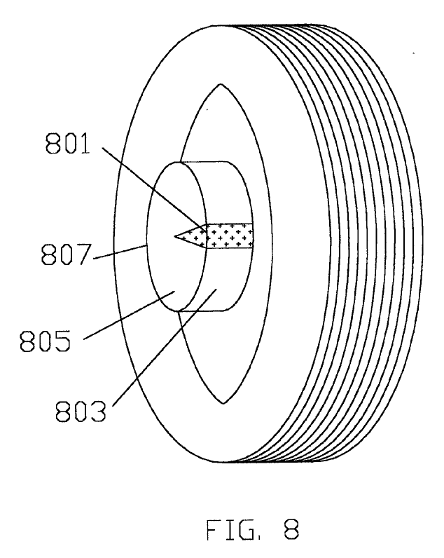

An advantageous embodiment, illustrated in FIG. 8, locates a safety spot (801) upon a raised center section (807) of the wheel (809), protruding outward from the side of the vehicle sufficiently to render the spot visible from behind or ahead of the vehicle. In the particular embodiment illustrated in FIG. 8, the safety spot (801) is located on a cylindrical protruding center section (807), extending across both a circumferential surface (803) and an outwardly facing base (805) of the cylindrical center section, so as to be visible both from the side of the vehicle and from in front of or behind the vehicle. Other embodiments similarly achieve visibility both from beside and from in front of or behind a vehicle upon which the wheel is mounted by locating safety spots on a protruding center section of the wheel, in the form of, for example and not by way of limitation, a raised dome or a raised cone. Another embodiment incorporates fins on the wheel, with surfaces facing both radially and axially to the wheel, on which safety spots are located.

In another embodiment, the protruding center section upon which the wheel safety spot is located is on a detachable wheel cover or hubcap, which can be added to an existing standard vehicle wheel.

In a further embodiment, safety spots are located on both a vehicle tire and a vehicle wheel upon which the tire is mounted. In a particular embodiment, safety spots are located both on the tread section of a vehicle tire, and on a wheel upon which the tire is mounted. In another particular embodiment, safety spots are located both on the tread and sidewall sections of a vehicle tire, and on a wheel upon which the tire is mounted.

As with the tire safety spot, in another embodiment the wheel safety spot is of a highly reflective material.

An additional embodiment of the safety spot is a separate visual indication member of some color, adapted to be affixed to a contrasting color tire body of a vehicle tire, whereby rotation of the vehicle tire causes the member to provide visual indication of vehicle movement. Another embodiment is a separate visual indication member adapted to be affixed to a contrasting color area of a vehicle wheel, whereby rotation of the vehicle wheel causes the member to provide visual indication of vehicle movement.

While the invention has been described in relation to the embodiments shown in the accompanying Drawing figures, other embodiments, alternatives, and modifications will be apparent to those skilled in the art. It is intended that the Specification be exemplary only, and that the true scope and spirit of the invention be indicated by the following claims.

What is claimed is:

1. A movement-indicating vehicle tire, comprising: a vehicle tire body of some color, having a tread, and a pair of opposed sidewalls, and a contrasting colored safety spot located on the tire body, whereby rotation of the vehicle tire causes the safety spot to provide visual indication of vehicle movement.

2. The vehicle tire of claim 1, wherein the safety spot is located on the tread.

3. The vehicle tire of claim 1 wherein the safety spot is located on a sidewall.

4. The vehicle tire of claim 1 wherein there are safety spots located on both the tread and a sidewall.

5. The vehicle tire of claim 1 wherein the safety spot traverses both the tread and a sidewall.

6. The vehicle tire of claim 1 wherein the safety spot is molded into the tire body.

7. The vehicle tire of claim 1 wherein the safety spot is of a highly reflective material.

8. The vehicle tire of claim 2 wherein multiple safety spots are located on the tread.

9. The vehicle tire of claim 2 wherein the safety spot extends across the tread between the sidewalls.

10. The vehicle tire of claim 2 wherein the safety spot extends straight across the tread from one sidewall to another sidewall.

11. The vehicle tire of claim 2 wherein the safety spot extends across the tread at an oblique angle from one sidewall to another sidewall.

12. The vehicle tire of claim 2 wherein the safety spot is molded into the tread.

13. The vehicle tire of claim 2 wherein the safety spot is of a highly reflective material.

14. The vehicle tire of claim 3 wherein the safety spot is molded into the sidewall.

15. The vehicle tire of claim 3 wherein the safety spot is of a highly reflective material.

16. The vehicle tire of claim 4 wherein the safety spot is molded into the tread and the sidewall.

17. The vehicle tire of claim 4 wherein the safety spot is of a highly reflective material.

18. The vehicle tire of claim 5 wherein the safety spot is of a highly reflective material.

19. The vehicle tire of claim 6 wherein the safety spot is of a highly reflective material.

20. The vehicle tire of claim 9 wherein the safety spot is molded into the tread.

21. The vehicle tire of claim 10 wherein the safety spot is molded into the tread.

22. The vehicle tire of claim 20 wherein the safety spot is of a highly reflective material.

23. The vehicle tire of claim 22 wherein the safety spot is of a highly reflective material.

24. The vehicle tire of claim 16 wherein the safety spot is of a highly reflective material.

25. A movement-indicating vehicle wheel, comprising: a vehicle wheel having a rim, and an outwardly facing surface of some color, and a contrasting colored safety spot located on the outwardly facing surface, whereby rotation of the vehicle wheel causes the safety spot to provide visual indication of vehicle movement.

26. The vehicle safety wheel of claim 25 wherein the outwardly facing surface has an axially protruding area, upon which at least a part of the safety spot is located and is visible from a direction radial to the wheel.

27. The vehicle safety wheel of claim 25 wherein the safety spot is of a highly reflective material.

28. A visual indication member of some color, adapted to be affixed to a contrasting color tire body of a vehicle tire, whereby rotation of the vehicle tire causes the member to provide visual indication of vehicle movement.

29. A visual indication member adapted to be affixed to a contrasting color area of a vehicle wheel, whereby rotation of the vehicle wheel causes the member to provide visual indication of vehicle movement.
